(19) United States
(12) Patent Application Publication
(10) Pub. No.: US 2024/0013174 A1
(43) Pub. Date: Jan. 11, 2024

(54) SYSTEM AND METHOD FOR IMPLEMENTING PAYMENT SERVICE PLATFORM

(71) Applicant: LYTE VENTURES PTE. LTD., SINGAPORE (SG)

(72) Inventors: HAO KWANG DENNIS GOH, SINGAPORE (SG); KWANG YUEN VINCENT HA, SINGAPORE (SG); HENRY TANO, SINGAPORE (SG); TECK BOON BRUNO POH, SINGAPORE (SG); ZHIYI NG, SINGAPORE (SG)

(21) Appl. No.: 18/020,960

(22) PCT Filed: Aug. 17, 2021
(86) PCT No.: PCT/SG2021/050481

§ 371 Date: Feb. 13, 2023

(30) Foreign Application Priority Data
Aug. 18, 2020 (SG) 10202007926V

(51) Int. Cl. G06Q 20/10; G06Q 20/40; G06Q 40/03

(52) U.S. Cl. CPC G06Q 20/102; G06Q 20/4016; G06Q 40/03

(57) ABSTRACT

The present disclosure relates to payment service platform and computer-implemented method for aggregating income receivables for freelancers for advancement. The method comprises ascertaining an outstanding balance limit, which is advanceable to a freelancer, based on eligible outstanding receivables and various risk factors which are associated with the freelancer and/or transaction classifications of the outstanding eligible receivables.

### CROSS-REFERENCE TO RELATED APPLICATION

The present application claims the benefit of the filing date of Singapore Patent Application No. 10202007926V entitled “Aggregation of income receivables of freelancers for advancement”, filed 18 Aug. 2020, and which is incorporated herein by reference.

### FIELD OF THE INVENTION

Embodiments of the invention related to payment service platform, particularly for aggregating income receivables for freelancers for advancement.

### BACKGROUND

Corporate entities (also known as “aggregators”) often unduly delay payment of income receivables due to freelancers. In Singapore, this delay may range between 30 to 120 days, though the delay is largely industry dependent and may be possibly longer. Even if there exists a contractual obligation between a corporate entity (also known as “aggregator”) and a freelancer for payment by the former to the latter by a certain date (also known as “payment term”), the freelancer is usually powerless to enforce the payment term given the power imbalance between the parties. Such delays may be caused by a myriad of factors such as but not limited to business practice, accounting practice, labour shortage, workflow inefficiency, technical inefficiency, etc. As a result of the aforementioned deficiency in aggregators' payment term, freelancers are often unable to receive payment from aggregators according to the contracted payment term which may cause financial difficulty to the freelancers.

Some aggregators may advance their own freelancers' income in return for a fee, effectively discounting the contracted payable amount. These advancement requests are usually done informally and on a per transaction or project basis. As a result, a freelancer who contracts with multiple aggregators on multiple transactions would find it extremely inconvenient (e.g., time-consuming) to liaise with each aggregator for each transaction. On the other hand, an aggregator which receives individual advancement requests from a large number of freelancers would also find it inconvenient (e.g. time-consuming and labour intensive) to deal with each request or assess risk of each request on a case-by-case basis. These inconveniences are at least partly due to a lack of technical infrastructure for processing such requests.

### SUMMARY

According to a first aspect of the invention, a computer-implemented method for a payment service platform is provided and comprises:
receiving, from an aggregator, a plurality of outstanding receivables associated with outstanding transactions of a freelancer as of a calculation date;
based on an elapse of the calculation date from a risk assessment date of each outstanding transaction by at least a relevant buffer interval, selecting a plurality of eligible outstanding receivables from among the outstanding receivables;
for each eligible outstanding receivable, based on an allowance for default risk associated with a transaction classification of the each eligible outstanding receivable, and further based on an outstanding concentrated risk due to proportion of the each eligible outstanding receivable in relation to the outstanding receivables, ascertaining a receivable credit limit; and
based on a freelancer credit limit associated with the freelancer and an aggregated total of the receivable credit limit of each eligible outstanding receivable, ascertaining an outstanding balance limit associated with the freelancer as of the calculation date.

In an embodiment of the first aspect, after ascertaining the outstanding balance limit associated with the freelancer as of the calculation date, the method further comprises:
receiving an input of an advance payment which is no more than the outstanding balance limit associated with the freelancer; and
generating a transfer instruction which is to cause a transfer of the advance amount to the freelancer.

In an embodiment of the first aspect, before receiving the outstanding receivables associated with the outstanding transactions of the freelancer as of the calculation date, the method further comprises:
receiving historical transaction data which includes historical transactions associated with different transaction classifications and different freelancers;
using the received historical transaction data, performing the following:
   for each historical transaction of each transaction classification, ascertaining a repayment interval between a risk assessment date and a repayment date, and ascertaining a buffer interval between the risk assessment date and an eligible date which and satisfies a predetermined return rate;
   for each transaction classification, ascertaining, from the buffer intervals associated therewith, an initial buffer interval, and adjusting the initial buffer interval to ascertain a relevant buffer interval which satisfies a predetermined buffer condition.

In an embodiment of the first aspect, the method further comprises:
using the received historical transaction data, performing the following:
   for each transaction classification, ascertaining a default rate and, based thereon, ascertaining the allowance for default risk.

In an embodiment of the first aspect, the method further comprises:
for each freelancer, based on the outstanding receivables, the relevant buffer interval, the allowance for default risk, and/or the outstanding concentrated risk, ascertaining the freelancer credit limit which satisfies a predetermined advance condition.

In an embodiment of the first aspect, the method further comprises:
using the received historical transaction data, performing the following:
   for each freelancer, assigning at least one of a plurality of bias classifications thereto, wherein the bias classifications are selected from any two or more selected from the group consisting of transaction classification, repayment interval, transaction count in each transaction classification, default rate.

In an embodiment of the first aspect, before receiving the outstanding receivables associated with the outstanding transactions of the freelancer as of the calculation date, the method further comprises:
receiving an advance service request having the calculation date which is for ascertaining the eligible income receivables.

In an embodiment of the first aspect, the outstanding receivables include invoices generated by the payment service platform.

In a second aspect of the invention, a payment service platform or system is provided and comprises:
a memory storage device and a computer processor communicably coupled thereto, wherein the computer processor is configured to:
   receive, from an aggregator, a plurality of outstanding receivables associated with outstanding transactions of a freelancer as of a calculation date;
   based on an elapse of the calculation date from a risk assessment date of each outstanding transaction by at least a relevant buffer interval, select a plurality of eligible outstanding receivables from among the outstanding receivables;
   for each eligible outstanding receivable, based on an allowance for default risk associated with a transaction classification of the each eligible outstanding receivable, and further based on an outstanding concentrated risk due to proportion of the each eligible outstanding receivable in relation to the outstanding receivables, ascertain a receivable credit limit; and
   based on a freelancer credit limit associated with the freelancer and an aggregated total of the receivable credit limit of each eligible outstanding receivable, ascertain an outstanding balance limit associated with the freelancer as of the calculation date.

In an embodiment of the second aspect, the computer processor is further configured to:
after ascertaining the outstanding balance limit associated with the freelancer as of the calculation date,
   receive an input of an advance payment which is no more than the outstanding balance limit associated with the freelancer; and
   generate a transfer instruction configured to cause a transfer of the advance amount to the freelancer.

In an embodiment of the second aspect, the computer processor is further configured to:
before receiving the outstanding receivables associated with the outstanding transactions of the freelancer as of the calculation date,
receive historical transaction data which includes historical transactions associated with different transaction classifications and different freelancers;
using the received historical transaction data, perform the following:
   for each historical transaction of each transaction classification, ascertain a repayment interval between a risk assessment date and a repayment date, and ascertaining a buffer interval between the risk assessment date and an eligible date which satisfies a predetermined return rate; and
   for each transaction classification, ascertain, from the buffer intervals associated therewith, an initial buffer interval, and adjust the initial buffer interval to ascertain a relevant buffer interval which satisfies a predetermined buffer condition.

In an embodiment of the second aspect, the computer processor is further configured to:
using the received historical transaction data, perform the following:
   for each transaction classification, ascertain a default rate and, based thereon, ascertaining the allowance for default risk.

In an embodiment of the second aspect, the computer processor is further configured to:
for each freelancer, based on the outstanding receivables, the relevant buffer interval, the allowance for default risk, and/or the outstanding concentrated risk, ascertain the freelancer credit limit which satisfies a predetermined advance condition.

In an embodiment of the second aspect, the processor is further configured to:
using the received historical transaction data, perform the following:
   for each freelancer, assign at least one of a plurality of bias classifications thereto, wherein the bias classifications are selected from any two or more selected from the group consisting of transaction classification, repayment interval, transaction count in each transaction classification, default rate.

In an embodiment of the second aspect, the computer processor is further configured to:
before receiving the outstanding receivables associated with the outstanding transactions of the freelancer as of the calculation date,
   receive an advance service request having the calculation date which is for ascertaining the eligible income receivables.

In an embodiment of the second aspect, the outstanding receivables include invoices generated by the payment service platform.

According to a third aspect of the invention, it is provided a non-transitory, computer readable medium, comprising code or computer-executable instructions that, when executed, directs a computer processor to perform the method according to the first aspect of the invention or any of its embodiments.

### BRIEF DESCRIPTION OF DRAWINGS

Embodiments of the invention will be described in detail with reference to the accompanying drawings, in which:

FIG. 1A provides a flowchart for interactions among an aggregator, a payment service platform, and a freelancer;

FIG. 1B provides a schematic diagram of a network comprising aggregators, a payment service platform, and freelancers;

FIG. 2 provides a flowchart for a method for ascertaining Risk Factor 1 (AVI risk), Risk Factor 2 (default risk) and/or Risk Factor 4 (overall exposure);

FIG. 3A provides a flowchart for a method for ascertaining Risk Factor 5 (bias) and credit limit;

FIG. 3B provides a flowchart for a method for performing Monte Carlo simulation;

FIG. 4 provides a flowchart for a method for ascertaining outstanding balance limit;

FIG. 5A provides an example graphical user interface showing an outstanding balance limit of a freelancer; and

FIG. 5B provides an example graphical user interface for receiving a freelancer's input of a desired advance amount.

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. It is understood that the terminology used herein is for the purpose of describing particular embodiments only, and is not intended to limit the scope of the invention. In the drawings, like reference labels or numerals refer to same or similar functionalities or features throughout the several views.

Embodiments described in the context of one of the devices or methods are analogously valid for the other devices or methods. Similarly, embodiments described in the context of a device are analogously valid for a method, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

It should be understood that the articles “a”, “an” and “the” as used with regard to a feature or element include a reference to one or more of the features or elements. The term “and/or” includes any and all combinations of one or more of the associated feature or element. The terms “comprising”, “including”, “having”, and any of their related terms, as used in description and claims, are intended to be open-ended and mean that there may be additional features or elements other than the listed ones. Identifiers such as “first”, “second”, “third”, and so on, are used merely as labels, and are not intended to impose numerical requirements on their objects, nor construed in a manner imposing any relative position or time sequence between limitations.

The term “coupled” and related terms are used in an operational sense and are not necessarily limited to a direct physical connection or coupling. Thus, for example, two devices may be coupled directly, or via one or more intermediary devices. Based on the present disclosure, a person of ordinary skill in the art will appreciate a variety of ways in which coupling exists in accordance with the aforementioned definition.

The term “aggregator” and its related term may refer to a corporate entity which contracts with a plurality of freelancers; its computing device or server or processor; and/or its bank or financial account, as appropriate according to the context.

The term “freelancer” and its related term may refer to an individual or a service provider who or which contracts with at least one aggregator, other than via employment contract; his computing device or server or processor; and/or his bank or financial account, as appropriate according to the context.

The term “earning” and its related term may refer to paid commission, paid income, or paid invoiced amount, as appropriate according to the context, and may be used interchangeably.

The term “receivable” and its related term may refer to commission paid, income paid, or invoiced amount, unpaid commission, unpaid income, or unpaid invoiced amount, as appropriate according to the context.

Embodiments of the invention provide method and system for a payment service platform which is particularly useful for freelancers and aggregators. For freelancers, embodiments of the invention may provide a service or platform for advancing their income receivables. For aggregators, embodiments of the invention may provide a service or platform for handling advancement requests.

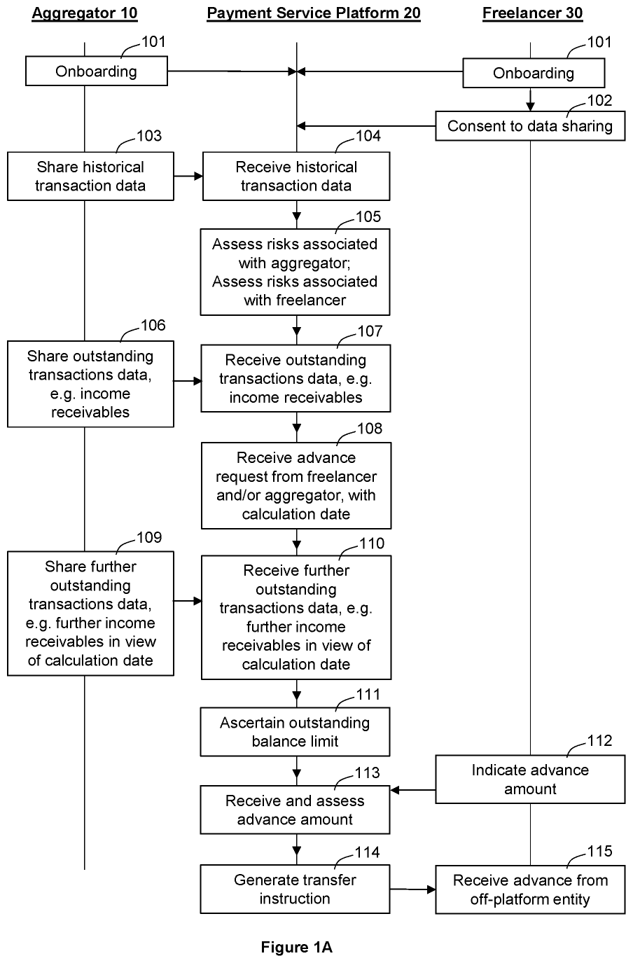

FIG. 1A shows a flowchart for interactions among an aggregator, a payment service platform or system, and a freelancer.

In block 101, onboarding of the aggregator 10 and the freelancer 30 to the payment service platform 20 is performed, at separate times or same time.

Onboarding of the aggregator 10 may include performing due diligence checks on the aggregator 10 (e.g. know-your-business (“KYB”) check) which may be performed manually or by appropriate application programming interfaces (“APIs”) via a website or application program, contracting with the aggregator 10, etc. Account access and privileges may be set up for at least one user representing the aggregator 10.

Onboarding of the freelancer 30 may include receiving identification information, personal information, and banking information of the freelancer 30, performing due diligence check on the freelancer 30 (e.g. know-your-client (“KYC”) check) which may be performed manually or by appropriate APIs via a website or application program. Account access and privileges may be set up for the freelancer 30.

Other onboarding processes and requirements not described above may be performed for the aggregator 10 and freelancer 30.

In block 102, the freelancer 30 provides consent for the aggregator 10 to share his transaction data with the payment service platform 20. This consent may be collected via a click-wrap agreement provided by the payment service platform 20. This consent may also be provided to the aggregator 10.

In block 103, the aggregator 10 shares historical transaction data (“HTD”) of aggregator and/or freelancers with the payment service platform (e.g. through API requests). The HTD may include historical transactions associated with at least different transaction classifications and different freelancers. Data for each historical transaction may include transaction classification, risk assessment date (“RAD”), repayment interval, earning or commission, performance, etc. The historical transaction data may relate to a predefined period (e.g. one or more years).

In an example relating to real estate industry, where a freelancer 30 is a real estate or property agent and an aggregator 10 is a real estate or property agency, transaction classification may include new project sale, resale sale, rental, etc. and optionally include further classification by housing types (e.g. government apartment, private apartment, private landed) or other appropriate type; RAD may refer to the date of signing or exercising an option-to-purchase, an intent to lease or other appropriate date; repayment interval may refer to a duration between the RAD and repayment date of earning; earning may refer to the commission accrued to the freelancer 30.

In block 104, the payment service platform 20 receives the aforementioned HTD of the freelancer 30 and/or the aggregator 10.

In block 105, based on the received HTD of the freelancer 30, the payment service platform 20 assesses risk factors associated with the freelancer 30; based on the received HTD of the aggregator 10, the payment service platform 20 assesses risk factors associated with the aggregator. More details of risk factors and their assessment are provided in the later paragraphs of this disclosure.

In block 106, the aggregator 10 shares outstanding transaction data of the freelancer 30 with the payment service platform 20. This may be on an on-going basis (e.g. real-time, near real-time, or at a predefined periodic interval). Outstanding transaction data may include, for each outstanding transaction, income receivable, transaction classification, RAD, projected or contracted repayment date, and/or invoice date.

In block 107, the payment service platform 20 receives the aforementioned outstanding transaction data of the freelancer 30 from the aggregator 10, which may be on an on-going basis.

In block 108, the payment service platform 20 receives an advance or cash-out request from the freelancer 20 and/or the aggregator 10. The advance request may include a calculation date, which may be the request submission date or another date (e.g. prior to the request submission date) based on which the payment service platform 20 will ascertain eligible income receivables.

In block 109, optionally, the aggregator 10 shares any further outstanding transaction data of the freelancer 30 with the payment service platform 20, in view of the calculation date.

In block 110, optionally, the payment service platform 20 receives the aforementioned any further outstanding transaction data of the freelancer 10 from the aggregator 30.

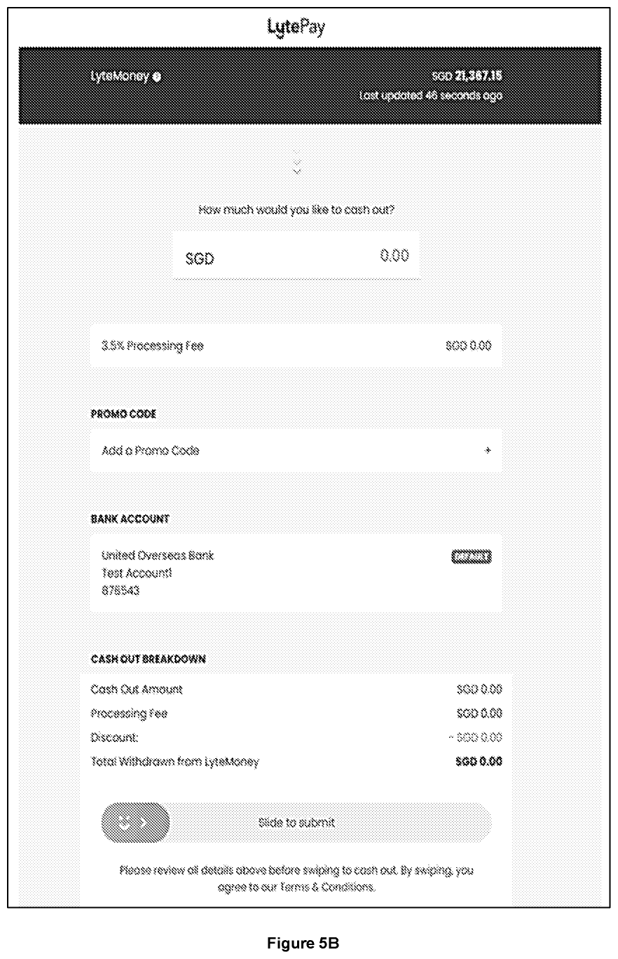

In block 111, based on the risk assessment performed in block 105 and the received outstanding transaction data of the freelancer 30, the payment service platform ascertains an outstanding balance limit (“OBL”) or final credit limit of the freelancer 30 as of the calculation date. This OBL provides a cap amount for the advance request. This OBL may be provided to the freelancer 30 on his computing device via a graphical user interface (“GUI”) (see FIG. 5A).

In block 112, the freelancer 30 inputs or specifies his desired advance amount using his computing device (see FIG. 5B). If the freelancer 30 decides to not proceed further with the advance request, the freelancer 30 may abort the advance request.

In block 113, the payment service platform 20 receives the freelancer's input.

In block 114, the payment service platform 20 ascertains or assesses whether the freelancer's input exceeds the OBL. If the freelancer's input does not exceed the OBL, the payment service platform 20 generates a transfer instruction which is to cause a transfer of an advance in the specified or other amount to the freelancer's predefined bank account, credit account or other financial account. The advance may include a deduction of a processing fee. Prior to the transfer, the payment service platform 20 may send a request to the freelancer 30 on his computing device for his confirmation; upon receiving the freelancer's confirmation, the payment service platform 20 may generate a transfer instruction and transmit this transfer instruction to an off-platform entity for executing the transfer of the advance.

In block 115, the freelancer 30 receives the specified advance in his bank account, credit card or other financial account. The advance transaction may be provided to the freelancer 30 on his computing device via a GUI (see FIG. 5A).

It is to be appreciated that various interactions among aggregator 10, payment service platform 20 and freelancer 30, as described in blocks 101 to 115, may utilise API.

FIG. 1B shows a schematic diagram of a network comprising aggregator devices 10, a payment service platform 20, and freelancer devices 30. Each of the aggregator devices 10 and freelancer devices 30 may be individually communicably coupled to the payment service platform 20 by wired and/or wireless connection. Each of the aggregator devices 10 and freelancer devices 30 may be provided with necessary hardware and/or software components known to a person skilled in the art. The payment service platform 20 may comprise a communication module 21, a processor 22, a memory 23 wherein the processor 22 is communicably coupled to the communication module 21 and the memory 23. Each of the aggregator devices 10 and freelancer devices 30 may similarly include at least the same components or modules. Each of the aggregator devices 10 and freelancer devices 30 may further include user input and/or output devices/interfaces (e.g. display screen for implementing GUI, interactive display screen for input and/or output, keyboard, key pad, mouse, etc.) communicably coupled to its respective communication module and the processor.

Communication module 21 may be any one or more receiver, transmitter, transceiver, and/or other components configured for wireless and/or wired communication.

Processor 22 may be any type of processor, such as a microprocessor, an embedded processor, a digital signal processor (DSP), a network processor, a multi-core processor, a single core processor, or other device to execute code. Although only one processor 22 is shown, a processing element may alternatively include more than one of processor 22 as shown. Processor 22 may be a single-threaded core or, for at least one embodiment, the processor 22 may be multi-threaded in that it may include more than one hardware thread context (or “logical processor”) per core. Processor 22 can execute any type of computer-executable instructions or code associated with flowcharts, algorithms, processes, or operations detailed herein. Generally, processor 22 can transform an element or an article (e.g., data) from one state or thing to another state or thing.

Memory 23 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM). Code or computer-executable instructions, associated with flowcharts, algorithms, processes, or operations detailed herein, may be stored in memory 23, or may be stored in software, hardware, firmware, or any suitable combination thereof, or in any other internal or external component, device, element, or object where appropriate and based on particular needs.

Risk factors mentioned in block 105 may include advance interval risk (“AVI”), default risk, concentration risk (“CR”), overall exposure, biases among freelancers. These risk factors will be described with reference to an example relating to real estate industry.

Risk Factor 1: Advance Interval Risk (“AVI”)

AVI refers to a time interval to collect an advanced commission (i.e. from advancing payment to the freelancer to receiving payment) which is due to the freelancer from the aggregator. For the real estate industry, to account for risk of uncertainty and duration of the AVI, repayment patterns from HTD are analysed.

In particular, HTD may include historical transactions having transaction classifications, risk assessment dates, repayment dates of earnings, freelancers, and/or earnings or commissions information associated with the respective transactions. In other words, each historical transaction includes a transaction classification, a RAD, an earning repayment date, a freelancer or its identifier, and/or an earning or commission amount or information. Repayment interval may be measured from the RAD to repayment date (i.e. payment of earning). RAD may refer to date of signing or exercising an option-to-purchase, or other appropriate date. A buffer interval or days may be ascertained to satisfy a predetermined return rate. The buffer interval or days is a time period (e.g. number of days) from the RAD, where an earning or commission is eligible to be included into the OBL. The buffer interval may be shorter than the repayment interval. An elapse of the buffer interval from the RAD therefore results in an eligible date (“ED”). The predetermined return rate may require a service or processing fee collected by the payment service platform on the advance and the cost of capital of the advance ensures a targeted return for the payment service platform and mitigation of this risk. For example, the buffer days may be calculated as the maximum number of days where the sales in the HTD reached on average a 7% net annual return (“NAR”) or 75% of the sales cover the costs of capital if they would have been advanced. Other NAR may be envisaged.

An additional risk may be considered, in view of the transaction count for a transaction classification as observed from the HTD. Additional buffer adjustment may also be considered.

In an example, the HTD of a transaction classification (e.g. new project sales) is received by the payment service platform. For each transaction observation in the HTD which is already repaid, time interval from the RAD to repayment of the earning is ascertained. For each project developer in the HTD for each year of the HTD, transaction count is ascertained. To base the calculations on more recent transactions, only year 2019 transactions for each developer are used if there are at least 100 transactions in year 2019 from a developer. If there are less than 100 transactions, year 2018 transactions may be used and check if there are now more than 100 transactions. If there are, transactions from years 2018 and 2019 are used. If there are less than 100 transactions, year 2017 transactions may be used and check if there are now more than 100 transactions. If there are, transactions from years 2017 until 2019 are used. If there are less than 100 transactions, year 2016 may be used and check if there are now more than 100 transactions. If there are, transactions from years 2016 until 2019 (the threshold of 100 transactions might be adjusted in other examples).

Cost of capital per annum and the service or processing fee in percent to be charged may be predefined but may be both adjustable variables. As the fee and cost of capital are both calculated on the same basis (i.e. the advanced amount) the payment service platform may ascertain how many days it can advance the money such that it achieves a certain NAR or until its NAR is zero. For each transaction in the HTD, the payment service platform may ascertain how many days after the RAD, the earning for that transaction could be advanced, such that from this date until the payment of the earning, the advance processing fee minus the cost of capital would have reached a certain NAR (e.g. 7% or 0%). It is assumed the number of days added to the RAD is “bufferDays1” for reaching 7% NAR and “bufferDays2” for reaching 0% NAR. Both target NARs are variables and may be adjusted as and when needed.

With this information, in one example, the payment service platform may ascertain for each project developer the mean and median “bufferDays1” and “bufferDays2”, and also ascertain a maximum of “bufferDays1” and “bufferDays2” (i.e. “maxBufferDays”). Depending on the transaction count the calculation of the buffer days is based on, additional days may be included on top of “maxBufferDays” to deal with uncertainty due to a limited amount of data to ascertain adjusted value (e.g. the resulting number is “bufferDays3”):
Additional 30 days are added if there are 10 transactions or less
No adjustment when there are at least 11 transactions

To be able to adjust the buffer days flexibly, a variable “BufferReduction” which can be set to a certain number of days may be introduced to adjust the “bufferDays3”. The resulting final buffer days may be “bufferDaysFinal” or a relevant buffer interval which may then be used to calculate the ED.

The above-described implementation may be similarly performed for another transaction classification (e.g. resale sales). However, modifications may be made, for example, a threshold transaction count (e.g. 100 transactions) may not be required.

The relevant buffer interval for each transaction classification may be stored at a memory at or communicably coupled to the payment service platform.

In another example, a default value for relevant buffer interval may be used to calculate the ED. In other examples, other methodologies for ascertaining relevant buffer interval may be utilised.

Risk Factor 2: Default Risk

To account for the risk of a commission defaulting, the payment service platform may analyse HTD for default share (“DS”) (or referred to as default rate) of each developer or property type (i.e. the percentage share of defaulted sales or aborted transactions with respect to the overall number of sales or transactions of the developer or property type).

This default share or default rate may directly impact how much percent of an earning or commission is included into a Credit Limit (“CL”) once it reaches the ED. The allowance of a freelancer's earning therefore depends on the DS of each transaction classification.

Once an earning or commission is invoiced by the property agency, the allowance of the earning or commission may be increased to 80%.

In another example, a default value for allowance for default risk may be used. In other examples, other methodologies for ascertaining allowance for default risk may be utilised.

Risk Factor 3: Concentration Risk (“CR”)

An earning or commission is labelled as CR if its value makes up 50% or more of the freelancer's OBL.

This imposes a risk as a default or late payment of such an earning can lead to delayed payment of advances and/or a default of an advance. The allowance of earnings with CR may be lowered by the variable “ConcRiskAdj” which is defined as a percentage. This leads to the final allowance being allowance—ConcRiskAdj for earnings which are labelled as CR. The final allowance may be adjusted if an earning is not labelled as CR or if the earning is invoiced. The allowance of invoiced earnings may always be 80% irrespective of the CR.

For example, if an earning is labelled as CR and it has reached the ED but is not invoiced yet, the allowance will be lowered by “ConcRiskAdj”. Once the earning is invoiced, the allowance will be increased to 80%. If an earning which is labelled as CR is already invoiced when it reaches the ED, the allowance will be 80%.

In another example, CR may not be considered when assessing an advance request or a default CR value may be used.

Risk Factor 4: Overall Exposure

To limit the overall exposure of the payment service platform in relation to the OBL, a maximum cap on each freelancer's OBL may be introduced. This maximum cap (or referred to as freelancer credit limit) may be calculated as the average yearly earnings over the past years (e.g. two years) of the freelancer as measured by the HTD. This may include project/resale/rental commissions, as well as tagger fess and management fees.

Assuming a worst case scenario where all outstanding earnings default and the freelancer has advanced all his OBL, it would take the payment service platform roughly one year (but probably less as the OBL does not allow to advance 100% of an earning) to collect the advanced amount back if the freelancer's performance is similar compared to the past years (e.g. two years).

In an example, if the average annual earning or maximum cap of the freelancer falls below 5,000 SGD, the maximum cap (“MinMaxCap”) may be set to 5,000 SGD to not have unduly restrictive cap.

In another example, if a freelancer has no or little historical earning, a default or other cap (e.g. outstanding receivables) may be utilised.

In another example, a maximum cap on the freelancer's OBL may not be imposed.

In other examples, other methodologies for ascertaining maximum cap or cap value may be utilised.

In an example, the aforementioned variables relating to Risk Factors 1 to 4 may be set to the following values:—

| Variable | Value |
|---|---|
| BufferReduction (=buffer days reduction) | 0 days |
| ConcRiskAdj (=allowance adjustment due to CR) | 10% |

For new freelancers or developers from whom there is no HTD, variables may be set to the following default values:

| Variable | Default Value |
|---|---|
| Default buffer days | 206 days |
| Default percentage allowance | 20% |
| Default maximum cap on the freelancer's CL | 9,500 SGD |

The default values may be calculated by taking conservative measures (e.g. 3^{rd} quartile or 90% quantile of the buffer days or 1^{st} quartile or 10% quantile of the default percentage allowance and default maximum cap on the freelancer's CL).

The payment service platform may store the average yearly earnings or MinMaxCap of each freelancer in a memory at or communicably coupled to the payment service platform for use in ascertaining CL.

It is to be appreciated that all variables and figures calculated or ascertained for Risk Factors 1 to 4 as well as any default variables are set to be variables and may be changed as and when needed (e.g. adapt to a new strategy or update with new data).

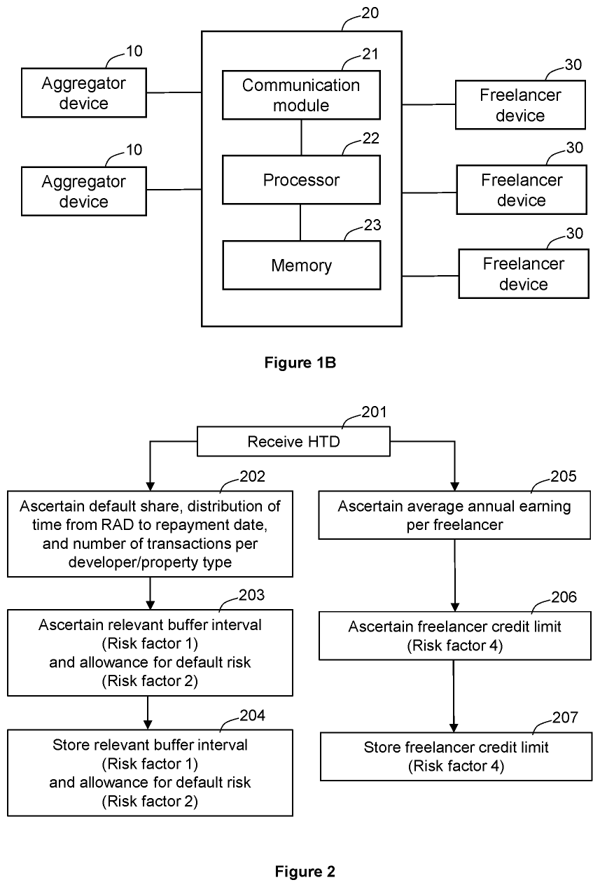

A method for ascertaining Risk Factor 1 (AVI risk), Risk Factor 2 (default risk) and/or Risk Factor 4 (overall exposure) may be described with reference to a flowchart of FIG. 2.

In block 201, a payment service platform receives HTD which includes historical transactions associated with different transaction classifications and different freelancers.

In block 202, using the received HTD, for each historical transaction of each transaction classification, the payment service platform ascertains a repayment interval between a RAD and a repayment date, and ascertains a buffer interval taken from the RAD, wherein the buffer interval is shorter than the repayment interval and satisfies a predetermined return rate (e.g. financial return rate).

For each transaction classification and/or project developer, the payment service platform ascertains a transaction default share or rate.

In block 203, using the received HTD, for each transaction classification, the payment service platform ascertains, from the buffer interval associated therewith, an initial buffer interval (e.g. average or median buffer interval), and adjusts the initial buffer interval to ascertain a relevant buffer interval which satisfies a predetermined buffer condition (e.g. adjusting the initial buffer interval based on transaction count or based on value of the initial buffer interval).

Based on the ascertained transaction default share or rate, the payment service platform ascertains an allowance for default risk for each transaction classification and/or project developer.

In block 204, the ascertained relevant buffer interval (e.g. for each transaction classification) and the ascertained allowance for default risk (e.g. for each transaction classification and/or project developer) are stored in a memory at or communicably coupled to the payment service platform.

In block 205 (optional), using the received HTD, for each freelancer, the payment service platform ascertains his historical average annual earning.

In block 206, based on the ascertained historical average annual earning (optional), outstanding receivables associated with a freelancer, a relevant buffer interval of outstanding transactions associated with the outstanding receivables, an allowance for default risk associated with the outstanding transactions, and/or outstanding concentrated risk of the freelancer, the payment service platform ascertains a freelancer credit limit (e.g. maximum advance) which satisfies a predetermined advance condition (e.g. a minimum cap amount regardless of historical average annual earning and/or a cap amount dependent on or regardless of historical average annual earning). This ascertained freelancer credit limit may provide a cap on the OBL or advance for the freelancer.

In block 207, the ascertained freelancer credit limit (e.g. for each or a particular freelancer) is stored in a memory at or communicably coupled to the payment service platform.

Risk Factor 5: Biases Among Freelancers

The payment service platform may utilise Monte Carlo Simulation to test the impact of biases among freelancers (e.g. eight biases and one non-bias set-up):—
0. No bias introduced
1. Freelancers with a high number of project sales (50% or more) in their sales history
2. Freelancers with only project sales in their sales history
3. Freelancers which face on average high repayment intervals (=3^{rd} quartile or above among all average repayment intervals. The repayment interval is defined as the time from RAD until the payment of the commission.) in their sales history
4. Freelancers with low number of sales (1^{st} quartile or lower among all number of sales per agent) in their sales history Freelancers with a high number of resale sales (50% or more) in their sales history
6. Freelancers with only resale sales in their sales history
7. Freelancers with a high share of aborted cases (95% quantile or above among all aborted shares per freelancer) in their sales history
8. Freelancers with a low number of rental sales (1^{st} quartile or below among all number of rental sales per agent) in their sales history

The above-described bias set-up is specifically for freelancers who are property agents and provides an illustrative example only. For freelancers in other industry, other bias set-up may be defined.

The freelancers may be classified in one or more bias groups.

In another example, a bias may not be ascertained or considered, or other bias groups or defining parameters may be utilised.

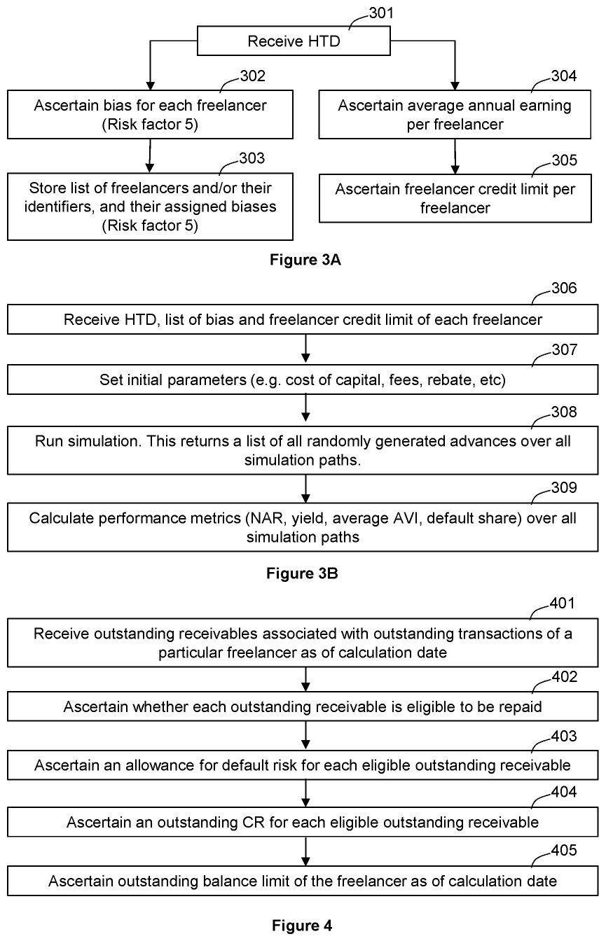

A method for ascertaining bias may be described with reference to a flowchart of FIG. 3A.

In block 301, the payment service platform receives HTD.

In block 302, bias for each freelancer is ascertained.

Based on the HTD for all rental, resale, and project transactions, the repayment interval (i.e. time in days from the RAD until the payment of the earning or commission) is ascertained for each transaction.

As the payment service platform may update the biases periodically (e.g. every 6 months), iteration steps over the time intervals of 6 months from the beginning of the data until the end are performed. In each iteration step (all the operations described in this paragraph are performed in each iteration step), data of the respective half year period is selected or subset from the HTD. The RAD may be used for the subsetting. For each freelancer (may be anonymised by identifiers), the portfolio shares of his resale, rental, and project sales may be ascertained. For example, if a freelancer has 10 project sales, 5 rental sales and 5 resale sales, his portfolio share would be 50% for projects, and 25% for resale and rental. With these shares, it is ascertained whether the freelancer belongs to bias 1, 2, 5, 6 or 8. Then, the average repayment interval for each freelancer is ascertained. The 3^{rd} quartile of all repayment intervals is ascertained and freelancers whose repayment interval is greater or equal to the 3^{rd} quartile are identified. This allows identification of the freelancers of bias 3. As a next step, the number of sales for each freelancer and the 1^{st} quartile of number of sales over all freelances are ascertained and freelancers whose number of sales are lower or equal to the 1^{st} quartile are identified. This allows identification of the freelancers of bias 4. Thereafter, for each freelancer, the share of aborted cases and the 95% quantile of the share of aborted cases among all freelancers are ascertained and the freelancers whose aborted share is greater or equal than the 95% quantile are identified. This allows identification of the freelancers of bias 7. Then, freelancers who are not among bias 1-8 are identified. These freelancers are identified as having no bias. This allows identification of freelances of bias 0.

In block 303, as a final step of the iteration, the predefined time period (e.g. 6 months) is saved and all freelancers and/or their identifiers for each bias 0-8 are saved into a list. In other words, each freelancer and/or his identifier) and his assigned or ascertained bias are stored in a memory at or communicably coupled to the payment service platform.

After iterating over all half year periods, a list of all time periods with the respective classification of the biases of the freelancers is obtained. Using new HTD by (e.g. updating the data over time), the biases may be ascertained without changing anything but the data to be used.

Ascertaining of Credit Limit (“CL”)

For each freelancer, from the beginning of the HTD until the end or for a defined time period (e.g. from year 2018 to 2019), a method for ascertaining credit limit and performing Monte Carlo simulation may be described with reference to a simplified flow charts of FIGS. 3A and 3B.

In block 301, the payment service platform receives HTD of all project sales, resale sales, and rental data as well as the buffer days (e.g. relevant buffer interval) and allowance in percent or equivalent (e.g. allowance for default risk) for each developer and property type (i.e. the data resulting from Risk Factor 1: AVI Risk; and Risk Factor 2: Default Risk), and the maximum cap on the credit limit from Risk Factor 3: Overall Exposure).

In block 304, the payment service platform iterates over each freelancer and ascertains the CL of each freelancer depending on his sales, the buffer days, the allowance in percent and the maximum cap. This ascertaining is also in view of Risk Factor 4: concentration risk. If an earning or commission is labelled as being a concentration risk (i.e. the volume of this earning makes up 50% or more of the CL), the allowance is lowered by the variable “ConcRiskAdj” (the variable can be set to a percentage, e.g. 10%). Once an earning is invoiced, the allowance may be set to 80%. Only resale and project commissions as well as project tagger fees may be included into the calculation of the CL. After ascertaining the CL for each freelancer over the defined time period, dates which a freelancer is repaid are also ascertained. As each earning of the freelancer would be collected, every earning source of the HTD would be valued when being paid.

In block 305, the CL for each freelancer is stored in a list which is saved. In other words, each freelancer and/or his identifier and his ascertained credit limit are stored in a memory at or communicably coupled to the payment service platform.

The CL may be ascertained or updated if HTD is updated or time interval for ascertaining CL is changed.

In block 306, Monte Carlo simulation may be initiated. The payment service platform receives or read the CL and bias classification(s), from the memory, for each freelancer.

In block 307, the following initial parameters may be defined:
The cost of capital
The fees charged (a vector of percentage fees)
An optional rebate on the fees
Which bias the simulation should use (more than one bias can be used)
The share of advances which will be assigned to bias freelancers (e.g. when this variable is 80%, 70% of the advances generated in the simulation will be done by freelancers of the bias category)
The start and end date of the simulation
How much percent of the overall number of freelancers is used in the simulation (to test for effects of different market size)
The frequency of advances modelled by a Poison process. This can control how often freelancers advance (e.g. it can be set such that freelancers on average advance once per month)
The random amount generated for each advance. This is set to a percent interval (e.g. when set to 10-100%, each advance amount will be generated to be randomly 10-100% of the current outstanding credit limit of the freelancer).
The number of simulation paths (e.g. when set to 200, the simulation will run 200 times).

In block 308, the simulation paths are iterated. Within each iteration (the process described in this paragraph applies to every iteration), a random pool of freelancers is drawn from all freelancers (e.g. defined by a predefined percentage). Random dates are drawn, and random number of advances are generated for each day depending on the defined frequency of advances. The advances are assigned to freelancers of the pool depending on the share of biased advances (e.g. when set to 80%, 80% of the randomly generated advances are assigned to freelancers of the bias category and 20% of advances are assigned to freelancers who are not in the bias category). A random advance amount is generated depending on the outstanding CL of the freelancer of the day of advance. It is checked whether the advance is above the CL. If it is not above, the future CL is lowered by the advance amount. The time until the repayment of the advance is calculated by using the information of the payments of the freelancers (generated in the CL calculation). If the advance defaults or partly defaults, this information is stored in the list as well to be able to calculate the losses occurring by the default. The advance amount and duration of the advance are stored in a list. This process continues over all advances generated in each simulation path.

After the simulations, a list of all randomly generated advances over all simulation paths is obtained and are stored in a memory at or communicably coupled to the payment service platform.

In block 309, the payment service platform ascertains processing fees depending on the defined interval of processing fees as well as the cost of capital for each successful advance or the overall cost of a default. The payment service platform may ascertain yield and NAR over the whole simulation paths, the default share as well as the average AVI. With this information, the payment service platform may assess how well the current CL set-up performs and how biases and different fees affect yields and returns.

Analysing different scenarios allows setting of the variables of the OBL calculation and testing of different pricing strategies.

With newly gathered data and the behaviour of aggregators, the payment service platform may test and monitor the performance of their algorithms and variables by updating the Monte Carlo Simulations with the new data and adjust assumptions on freelancers' behaviour with insights from the aggregators.

In another example, the initial parameters may be adjusted and/or defined differently.

Ascertaining of Outstanding Balance Limit (OBL)

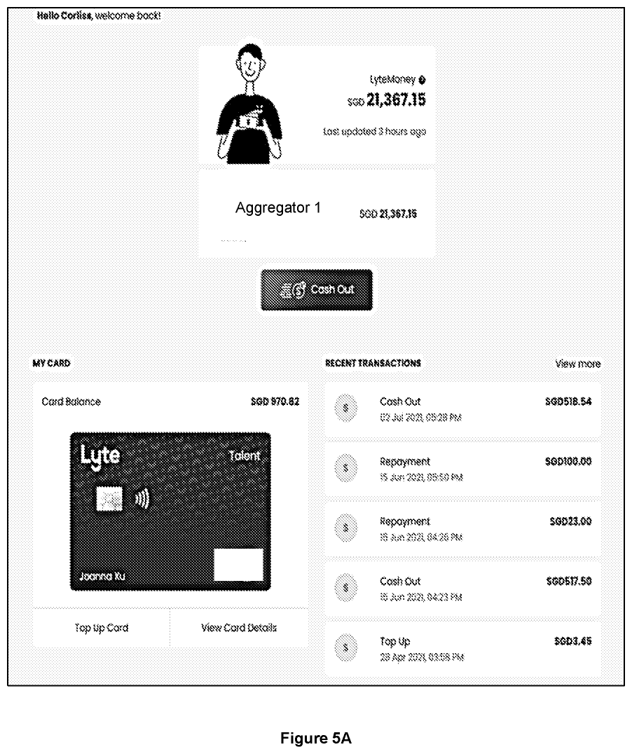

A method for ascertaining OBL may be described with reference to a flowchart of FIG. 4. The method may be performed in block 111 of FIG. 1A.

In block 401, the payment service platform receives outstanding receivables associated with outstanding transactions of a particular freelancer as of a calculation date (also see blocks 109 and 110 of FIG. 1A). This calculation date may be real-time or defined by the freelancer or aggregator. This receipt of data relating to outstanding receivables may be in response to an advance request, including the calculation date, from the freelancer and/or an aggregator (also see block 108 of FIG. 1A).

In block 402, the payment service platform ascertains whether each outstanding receivable is eligible to be repaid. This may be done by ascertaining, for each outstanding receivable, whether the calculation date falls on or after a relevant buffer interval from a RAD. If the calculation date has elapsed from the RAD by at least the relevant buffer interval, the outstanding receivable is selected or ascertained as an eligible outstanding receivable. If not, the outstanding receivable is not selected nor ascertained as an eligible outstanding receivable. The relevant buffer interval may be the ascertained value from block 203 or 204, or a predetermined or default value. Notwithstanding the above, an outstanding receivable may be selected or ascertained as an eligible outstanding receivable if it has been invoiced.

In block 403, the payment service platform ascertains an allowance for default risk for each eligible outstanding receivable based on a transaction classification associated therewith. This allowance for default risk may be the ascertained value from block 203 or 204 (e.g. based on developer/property types), or a predetermined or default value which may be determined based on the invoice status of the receivable, or another predetermined or default value.

In block 404, the payment service platform ascertains an outstanding CR for each eligible outstanding receivable. This outstanding CR may be based on a portfolio weight or derived from a proportion of each eligible outstanding receivable in relation to the total outstanding receivables.

In block 405, based on the ascertained allowance for default risk from block 403 and outstanding CR from block 404, the payment service platform ascertains a credit limit for each eligible transaction and, based thereon, ascertains an aggregated total credit limit for the freelancer's eligible outstanding receivables. Based on the freelancer credit limit, which may be derived from block 304 or 305, and the aggregated total credit limit for the freelancer's eligible outstanding receivables, the payment service platform ascertains an OBL or final credit limit for the freelancer as of the calculation date (also see block 111 of FIG. 1A). This OBL or final credit limit provides a maximum advance that may be made to the freelancer on the calculation date. This value may be presented to the freelancer via a GUI (see FIG. 5A for an example interface showing an OBL of a freelancer).

Based on the ascertained OBL or final credit limit for the freelancer as of the calculation date, the freelancer may indicate to the payment service platform an advance amount (capped at the ascertained OBL or final credit limit) to be paid to him (see FIG. 5B for an example interface for receiving a freelancer's input on advance amount).

Upon receiving the freelancer's input (see block 113 of FIG. 1A), the payment service platform ascertains whether the freelancer's input is within the OBL or final credit limit and, if it is, the payment service platform generates a transfer instruction and transmit the transfer instruction to an off-platform entity to execute the transfer of the advance to the freelancer (see block 114 of FIG. 1A). The advance amount may incorporate a service or processing fee. The advance amount may be transferred to a bank account, a credit card, or other financial account which may be predefined by the freelancer. The freelancer then receives the advance (see block 115 of FIG. 1A). On the other hand, if the payment service platform ascertains that freelancer's input exceeds the OBL or final credit limit, the payment service platform may inform the freelancer via the GUI of the input discrepancy and does not proceed with the requested input. The payment service may receive a new input and assess the same.

In the foregoing description, while all five risk factors are utilised in the ascertaining of OBL, it is to be appreciated that in other examples, only some of the five risk factors may be utilised in any combination.

In an example, the payment service and/or its platform may be implemented via a web application. In another example, the payment service and/or its platform may be implemented via a mobile application.

Advantageously, the payment service platform contracts directly with aggregators that engage freelancers, and provides both parties an advance or a cash-out service. The payment service platform feeds income receivables data obtained from aggregator's API into a credit limit algorithm, yields a credit limit amount (i.e. outstanding balance limit) based on which a freelancer can request an advancement at the point of a calculation date. Aggregators and freelancers do not have to transact on each advance individually as the payment service platform allows receivables of a freelancer to be aggregated and assessed as a whole which results in at least operational efficiency and better risk mitigation. This also translates into lower costs and better returns for both aggregators and freelancers. Furthermore, the use of an independent payment service platform is beneficial to aggregators which may lack technical skillset, technical infrastructure, and operational resource to implement such platform. On the other hand, an aggregator-implemented platform may be viewed with prejudice.

Advantageously, the payment service platform provides an independent, aggregated, reliable and trusted platform through which advance requests from aggregators and freelancers are processed in an efficient, accurate, and consistent manner. The payment service platform is provided with access to a large amount of historical data maintained by aggregator in respect of its whole or part user base, thus allowing for better or holistic risk assessment and risk mitigation framework, and hence lower advance cost. The payment service platform may receive newly-generated transaction data from the aggregator either periodically or on real-time basis, and utilise the newly-generated transaction to update risk factor assessment and assess outstanding receivables. Furthermore, an API is set up between an aggregator and a payment service platform instead of requiring an API to be set up between the aggregator and each user. Hence, the payment service platform is able to obtain a wide range of data, maintain data which is up to date and accurate, and also update risk factor assessment and ascertain outstanding balance limit more quickly and efficiently without multiplicity of API calls or experiencing latency due to multiplicity of API calls. As data format of data provided by aggregator is more consistent as compared to data from free sources, the payment service platform is also able to benefit from consistency in data format.

In an example, the payment service platform may be employed for invoice factoring in any suitable industry. A freelancer may generate an invoice via the payment service platform and send the invoice to his client. The client will have the option to accept the invoice. This process will be reflected by status changes in the system (e.g. invoice generated, invoice sent, invoice accepted). The payment service platform may offer an OBL based on the freelancers' outstanding invoices. Several risk metrics are taken into consideration to mitigate the risk of this product. These can be categorised the same five risk categories as before, but the risk itself may need to be identified and mitigated differently.

In respect of Risk Factor 1 (AVI Risk), to account for risk of uncertainty and duration of the AVI, repayment patterns for each freelancer and client may be analysed from the HTD. A key metric is the deviation of the payment from the due date of the invoice. However, as there are more players in this market, it might not always be possible to get enough observations for one party to assess the risk properly. In that case, the risk may be assessed for one market in total (e.g. the freelancer market in Singapore). From that, it may be ascertained how punctual freelancers in Singapore are paid. For this market, the distribution of the deviation of the payment date may be computed from the invoice date. It may be ascertained when 90% of the invoices are repaid and derive buffer days from that (e.g. 90% of invoices are repaid within 20 days after the due date. Buffer days are 20 in this example.). Accordingly, the risk assessment date (RAD) may be defined as the due date. This allows us calculation of a conservative measure for the expected payment date (“EPD”). In this example, “due date+20 days” may be used instead of the due date as EPD. This will allow calculation of a fee over a time horizon in which 90% of the invoices should be repaid. As invoices will also be repaid earlier, these cases will help the payment service platform finance the 10% of cases which are paid later than the EPD.

If a freelancer or client has enough historical data to evaluate his AVI risk, he will be assigned his own buffer days in the same way as described above.

In respect of Risk Factor 2 (Default Risk), if freelancer invoice factoring is new in a particular market, it may be difficult to predict whether this service will result in behavioural changes in the market (e.g. fraudulent behaviour). Therefore, the HTD alone might not be sufficient to mitigate default risk. Hence, the percentage of the invoice amount (allowance) which is enabled to be advanced is linked to how many successfully repaid invoices the freelancer has with the payment service platform. Therefore, the initial invoices may have an allowance of 0%. With more repaid invoices the allowance may increase. For example, with 4 or more invoices repaid, the allowance could increase to 20%.

Subsequently, with more HTD, default risk assessment may be switched to freelancer and client-based risk approach in regard. However, a freelancer may still need 3 successfully repaid invoices with the payment service platform to obtain a positive allowance.

Then, to account for the risk of an invoice defaulting, the default share (“DS”) (or referred to as default rate) of each freelancer and client (i.e. the percentage share of defaulted invoices with respect to the overall number of invoices of the freelancer or client) may be analysed from the HTD.

This default share may directly impact how much percent of an invoice is included into the CL. The allowance of a freelancer's invoice therefore depends on his and the clients' DS.

This will result in two allowances for one invoice (i.e. one allowance for each of the freelancer and client). The updated allowance for an invoice may be the minimum of these two allowances.

In respect of Risk Factor 3 (Concentration Risk), an invoice may be labelled as CR if the value of that invoice makes up 50% or more of the freelancer's outstanding balance limit. This imposes risk as a default or late payment of such an invoice can lead to delayed payment of advances and/or a default of an advance. The allowance of invoices with CR may be lowered by the variable “ConcRiskAdj” which is defined as a percentage. This leads to the final allowance being allowance—ConcRiskAdj for invoices which are labelled as CR. The final allowance may not be adjusted if an invoice is not labelled as CR.

In respect of Risk Factor 4 (Overall Exposure), to limit the overall exposure of the payment service platform in relation to OBL, a maximum cap on each freelancer's OBL may be introduced. This maximum cap is calculated as the average yearly earnings over the past two years measured by the HTD.

Assuming a worst case scenario where all outstanding commissions default and the freelancer advanced all his OBL, it may take the payment service platform roughly one year (but probably less as the OBL does not allow to advance 100% of a commission) to collect the advanced amount back if the freelancer's performance is similarly compared to the past two years.

If the maximum cap of the freelancer falls below 5,000 SGD, the maximum cap “MinMaxCap” may be set to 5,000 SGD to not have an unduly restrictive cap.

As there may be insufficient data of a freelancer to calculate the average yearly earnings, the maximum cap may be calculated once it is possible. Initially, the default maximum cap for each freelancer may be set as a basic value.

In relation to Risk Factor 5 (Biases among aggregators), the payment service provider may use Monte Carlo Simulations to test the impact of biases among aggregators (e.g. test 3 biases and one non-bias set-up):—
0. No bias introduced
1. Freelancers which face on average late repayments (=3^{rd} quartile or above among all due date deviations. The due date deviation is defined as number of days an invoice is paid after the due date)
2. Freelancers with low number of sales (1^{st} quartile or lower among all number of sales per agent) HTD
3. Freelancers with a high share of defaulted invoices (95% quantile or above among all default shares per freelancer) in the HTD

The Monte Carlo simulation may be set up in the same way as the one for the example relating to property agents. However, the HTD used may be from years 2015 to 2021. The biases may be updated every 6 or 12 months.

It is to be appreciated that the flow charts showing logic flows are representative of exemplary methodologies for performing novel aspects of the invention. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The flow charts showing logic flow may be implemented in software, firmware, hardware, or any combination thereof. In software and firmware embodiments, a logic flow may be implemented by computer executable instructions or code stored on a non-transitory computer readable medium or machine readable medium, such as an optical, magnetic or semiconductor storage. The embodiments are not limited in this context.

It is to be understood that the embodiments and features described above should be considered exemplary and not restrictive. Many other embodiments will be apparent to those skilled in the art from consideration of the specification and practice of the invention. Furthermore, certain terminology has been used for the purposes of descriptive clarity, and not to limit the disclosed embodiments of the invention.

1.-17. (canceled)

18. A computer-implemented method for a payment service platform, the method comprising:
receiving, from a plurality of aggregators, historical transaction data which includes historical transactions associated with different transaction classifications and different freelancers;
using the received historical transaction data, performing the following:
for each historical transaction of each transaction classification, ascertaining a repayment interval between a risk assessment date and a repayment date, and ascertaining a buffer interval between the risk assessment date and an eligible date which is shorter than the repayment interval and satisfies a predetermined return rate;
for each transaction classification, ascertaining, from the buffer intervals associated therewith, an initial buffer interval, and adjusting the initial buffer interval to ascertain a relevant buffer interval which satisfies a predetermined buffer condition;
receiving an advance service request having a calculation date which is for ascertaining a plurality of eligible outstanding receivables;
receiving, from the aggregators, a plurality of outstanding receivables associated with outstanding transactions of a freelancer as of the calculation date;
based on an elapse of the calculation date from a risk assessment date of each outstanding transaction by at least the relevant buffer interval, selecting the eligible outstanding receivables from among the outstanding receivables;
for each eligible outstanding receivable, based on an allowance for default risk associated with a transaction classification of the each eligible outstanding receivable, and further based on an outstanding concentrated risk due to proportion of the each eligible outstanding receivable in relation to the outstanding receivables, ascertaining a receivable credit limit; and
based on a freelancer credit limit associated with the freelancer and an aggregated total of the receivable credit limit of each eligible outstanding receivable, ascertaining an outstanding balance limit associated with the freelancer as of the calculation date;
receiving an input of an advance payment which is no more than the outstanding balance limit associated with the freelancer; and
generating a transfer instruction which is to cause a transfer of the advance amount to the freelancer.

19. The method according to claim 18, further comprising:
using the received historical transaction data, performing the following:
for each transaction classification, ascertaining a default rate and, based thereon, ascertaining the allowance for default risk.

20. The method according to claim 19, further comprising:
for each freelancer, based on the outstanding receivables, the relevant buffer interval, the allowance for default risk, and/or the outstanding concentrated risk, ascertaining the freelancer credit limit which satisfies a predetermined advance condition.

21. The method according to claim 18, further comprising:
using the received historical transaction data, performing the following:
for each freelancer, assigning at least one of a plurality of bias classifications thereto,
wherein the bias classifications are selected from any two or more selected from the group consisting of transaction classification, repayment interval, transaction count in each transaction classification, default rate.

22. The method according to claim 18, wherein the outstanding receivables include invoices generated by the payment service platform.

23. A payment service platform comprising:
a memory storage device and a computer processor communicably coupled thereto, wherein the computer processor is configured to:
receive, from a plurality of aggregators, historical transaction data which includes historical transactions associated with different transaction classifications and different freelancers;
using the received historical transaction data, perform the following:
for each historical transaction of each transaction classification, ascertain a repayment interval between a risk assessment date and a repayment date, and ascertaining a buffer interval between the risk assessment date and an eligible date which is shorter than the repayment interval and satisfies a predetermined return rate; and
for each transaction classification, ascertain, from the buffer intervals associated therewith, an initial buffer interval, and adjust the initial buffer interval to ascertain a relevant buffer interval which satisfies a predetermined buffer condition;
receive an advance service request having a calculation date which is for ascertaining the eligible income receivables;
receive, from the aggregators, a plurality of outstanding receivables associated with outstanding transactions of a freelancer as of the calculation date;
based on an elapse of the calculation date from a risk assessment date of each outstanding transaction by at least the relevant buffer interval, select the eligible outstanding receivables from among the outstanding receivables;
for each eligible outstanding receivable, based on an allowance for default risk associated with a transaction classification of the each eligible outstanding receivable, and further based on an outstanding concentrated risk due to proportion of the each eligible outstanding receivable in relation to the outstanding receivables, ascertain a receivable credit limit;
based on a freelancer credit limit associated with the freelancer and an aggregated total of the receivable credit limit of each eligible outstanding receivable, ascertain an outstanding balance limit associated with the freelancer as of the calculation date;
receive an input of an advance payment which is no more than the outstanding balance limit associated with the freelancer; and
generate a transfer instruction configured to cause a transfer of the advance amount to the freelancer.

24. The payment service platform according to claim 23, wherein the computer processor is further configured to:
using the received historical transaction data, perform the following:
for each transaction classification, ascertain a default rate and, based thereon, ascertaining the allowance for default risk.

25. The payment service platform according to claim 24, wherein the computer processor is further configured to:
for each freelancer, based on the outstanding receivables, the relevant buffer interval, the allowance for default risk, and/or the outstanding concentrated risk, ascertain the freelancer credit limit which satisfies a predetermined advance condition.

26. The payment service platform according to claim 23, wherein the processor is further configured to:
using the received historical transaction data, perform the following:
for each freelancer, assign at least one of a plurality of bias classifications thereto,
wherein the bias classifications are selected from any two or more selected from the group consisting of transaction classification, repayment interval, transaction count in each transaction classification, default rate.

27. The payment service platform according to claim 23, wherein the outstanding receivables include invoices generated by the payment service platform.

28. A non-transitory, computer readable medium, comprising code that, when executed, directs a computer processor to perform the method according to claim 18.
